(19) United States
(12) Patent Application Publication
(10) Pub. No.: US 2021/0403039 A1
(43) Pub. Date: Dec. 30, 2021

(54) ARITHMETIC OPERATION SYSTEM FOR VEHICLE

(71) Applicant: Mazda Motor Corporation, Hiroshima (JP)

(72) Inventors: Daisuke Horigome, Aki-gun (JP); Shinsuke Sakashita, Aki-gun (JP); Masato Ishibashi, Aki-gun (JP); Eiichi Hojin, Aki-gun (JP); Akihiro Mitani, Aki-gun (JP); Kiyoyuki Tsuchiyama, Aki-gun (JP)

(73) Assignee: Mazda Motor Corporation, Hiroshima (JP)

(21) Appl. No.: 17/468,699

(22) Filed: Sep. 8, 2021

Related U.S. Application Data
(63) Continuation of application No. PCT/JP2020/008850, filed on Mar. 3, 2020.

(30) Foreign Application Priority Data
Mar. 8, 2019 (JP) 2019-042926
Mar. 8, 2019 (JP) 2019-042927
Mar. 8, 2019 (JP) 2019-042928

(51) Int. Cl. B60W 60/00; B60W 30/09; B60W 30/14; B60W 40/08; B60W 40/10; B60W 40/02; B60W 10/20; G06N 3/08; G06K 9/00

(52) U.S. Cl. CPC B60W 60/0011; B60W 30/09; B60W 30/143; B60W 40/08; B60W 40/10; B60W 2540/221; B60W 10/20; G06N 3/08; G06K 9/00805; B60W 2040/0872; B60W 40/02

(57) ABSTRACT

A vehicle arithmetic system includes a single information processing circuitry. performs control of vehicle external environment estimation circuitry configured to receive outputs from sensors that obtain information of a vehicle external environment, and estimate the vehicle external environment including a road and an obstacle; a route generation circuitry configured to generate a traveling route of the vehicle which avoids the obstacle estimated on the road estimated, based on an output from the vehicle external environment estimation unit; and a target motion determination circuitry configured to determine a target motion of the vehicle so that the vehicle travels along the traveling route generated by the route generation circuitry.

### CROSS-REFERENCE TO RELATED APPLICATIONS

The present application claims priority to international application PCT/JP2020/008850, filed Mar. 3, 2020, Japanese application number 2019-042926 filed in the Japanese Patent Office on Mar. 8, 2019, Japanese application number 2019-042927 filed in Japanese Patent Office on Mar. 8, 2019, and Japanese application number 2019-042928 filed in Japanese Patent Office on Mar. 8, 2019, the entire contents of each are incorporated herein by its reference.

### TECHNICAL FIELD

The present disclosure relates to a vehicle arithmetic system used for autonomous driving of a vehicle, for example.

### BACKGROUND ART

Patent Document 1 discloses a system for controlling a plurality of on-board devices, such as an engine and a steering wheel, mounted in a vehicle. To control the plurality of on-board devices, the control system has a hierarchical configuration including an integrated controller, a domain controller, and a unit controller.

### CITATION LIST

### Patent Document

Patent Document 1: Japanese Unexamined Patent Publication No. 2017-061278

### SUMMARY

### Technical Problems

As a non-limiting example of technical problems addressed by the present disclosure, in order to achieve a highly accurate autonomous driving, it is necessary to perform comprehensive determination to control a motion of the vehicle, based on various information including not only the environment around the vehicle but also the state of the driver, the state of the vehicle, and the like. To this end, as recognized by the present inventors, there is a need for processing, at high speed, an enormous volume of data from cameras, sensors, or a vehicle-external network, and the like to determine a most suitable motion of the vehicle for every moment and operate each actuator, which leads to a need to construct an arithmetic system that accomplishes this procedure.

In view of the foregoing background, one aspect of the present disclosure to provide a vehicle arithmetic system for achieving highly accurate autonomous driving.

### SUMMARY

Specifically, the various techniques disclosed herein included techniques directed to a vehicle arithmetic system mounted in a vehicle and configured to execute calculation for controlling traveling of the vehicle, the system including a single information processing unit, wherein the information processing unit includes: a vehicle external environment estimation unit configured to receive outputs from sensors that obtain information of a vehicle external environment, and estimate the vehicle external environment including a road and an obstacle; a route generation unit configured to generate a traveling route that avoids the obstacle estimated on the road estimated, based on an output from the vehicle external environment estimation unit; and a target motion determination unit configured to determine, based on an output from the route generation unit, a target motion of the vehicle at a time of traveling along the traveling route generated by the route generation unit.

According to this configuration of the vehicle arithmetic system, the single information processing unit includes: the vehicle external environment estimation unit configured to receive the outputs from the sensors that obtain the information of the vehicle external environment, and estimate the vehicle external environment including a road and an obstacle; the route generation unit configured to generate the traveling route of the vehicle which avoids the obstacle estimated on the road estimated, based on the output from the vehicle external environment estimation unit; and the target motion determination unit configured to determine the target motion of the vehicle so that the vehicle travels along the traveling route generated by the route generation unit. That is, the information processing unit configured as a single piece of hardware achieves functions of estimating the vehicle external environment, generating the route, and determining the target motion. This enables high-speed data transmission among the functions, and suitable control of the entire functions. Thus, centralizing processes for the autonomous driving in a single information processing unit enables highly accurate autonomous driving.

The information processing unit may include an energy management unit configured to calculate a driving force, a braking force, and a steering angle to achieve the target motion determined by the target motion determination unit.

According to this configuration, it is possible not only to estimate the vehicle external environment, generate the route, and determine the target motion with the information processing unit configured as a single piece of hardware, but also to manage energy with the information processing unit. Thus, the vehicle arithmetic system allows highly accurate control of the motion of the vehicle according to the environment around the vehicle. In addition, highly accurate autonomous driving, which takes into account the vehicle behavior and energy consumption, is possible by centralizing processes for the autonomous driving in the single information processing unit.

The energy management unit may compare the driving force, the braking force, and the steering angle that have been calculated with a vehicle energy model, and generate control signals for actuators so as to achieve the driving force, the braking force, and the steering angle.

According to this configuration of the vehicle arithmetic system, the energy management unit can generate the control signal for each actuator according to an output from the target motion determination unit.

In addition, the information processing unit may include a driver state estimation unit configured to receive an output from a sensor that measures a state of a driver and estimate the state of the driver including at least one of a physical behavior or a health condition, and the route generation unit may generate a route that is suitable for the state of the driver estimated by the driver state estimation unit.

According to this configuration, it is possible not only to estimate the vehicle external environment, generate the route, and determine the target motion with the information processing unit configured as a single piece of hardware, but also to estimate the driver's state with the information processing unit. Further, the route generation unit generates a route that is suitable for the state of the driver estimated by the driver state estimation unit. The above configuration therefore makes it possible to control the motion of the vehicle, based on comprehensive determination based not only on the environment around the vehicle, but also on the state of the driver.

The driver state estimation unit may estimate the state of the driver by comparing, with a human model, the output from the sensor that measures the state of the driver.

According to this configuration, the driver state estimation unit estimates the state of the driver by comparing, with a human model, the output from the sensor, such as a camera and the like arranged in the passenger compartment, which measures the state of the driver. The above configuration therefore makes it possible to control the motion of the vehicle more accurately, based on comprehensive determination based not only on the environment around the vehicle, but also on the state of the driver.

In addition, the target motion determination unit may use an output from the driver state estimation unit to determine the target motion of the vehicle, including a planar motion of the vehicle and changes in a vehicle posture in up/down directions, so that the vehicle travels along the traveling route generated by the route generation unit.

According to this configuration, the target motion of the vehicle is determined by using the output from the driver state estimation unit, in addition to the output from the route generation unit. Thus, the comprehensive determination can be made based not only on the environment around the vehicle, but also on the state of the driver, in not only generating the route and but also determining the target motion.

In addition, the vehicle external environment estimation unit may estimate the vehicle external environment by comparing, with a vehicle external environment model, 3-dimensional information on surroundings of the vehicle, the 3-dimensional information being obtained from the outputs of the sensors that obtain information of the vehicle external environment.

According to this configuration, the vehicle external environment estimation unit receives an output from the sensors, such as a camera and a radar, which are mounted on the vehicle and obtain information of the vehicle external environment, and compares the 3-dimensional information on the surroundings of the vehicle with the vehicle external environment model to estimate the vehicle external environment including the road and an obstacle. This enables appropriate control of motion of the vehicle through arithmetic processing using the vehicle external environment model.

In addition, the target motion determination unit may estimate a planar motion of the vehicle and changes in a vehicle posture in up/down directions, which occur when the vehicle travels along the traveling route generated by the route generation unit, by referring to a 6DoF model of the vehicle, and determine the planar motion and the changes in the vehicle posture in the up/down directions which have been estimated, as the target motion of the vehicle, the 6DoF model of the vehicle being obtained by modeling acceleration along three axes, namely, in forward/backward, left/right, and up/down directions of the vehicle that is traveling, and an angular velocity along three axes, namely, pitch, roll, and yaw.

This configuration enables appropriate control of motion of the vehicle through arithmetic processing using the 6DoF model of the vehicle.

### Advantages

With the present disclosure, the information processing unit, which in one embodiment is configured as a single piece of hardware, and in other embodiments can be shared processors or even remote processor(s) including cloud computing resources, achieves functions of estimating the vehicle external environment, generating the route, and determining the target motion. This enables high-speed data transmission among the functions, and suitable control of the entire functions. Thus, centralizing processes for the autonomous driving in a single information processing unit enables highly accurate autonomous driving.

### BRIEF DESCRIPTION OF THE DRAWINGS

FIG. 1 illustrates a functional configuration of a vehicle arithmetic system according to an embodiment.

FIG. 2 illustrates an exemplary configuration of an information processing unit.

FIG. 3 illustrates specific examples of actuators of a vehicle and controllers thereof.

FIG. 4. is a diagram of an AI-based computer architecture according to an embodiment.

FIG. 5 is an example diagram of an image used for training a model to detect distance to an obstacle and a protection zone around the obstacle.

FIG. 6 is a diagram of a data extraction network according to an embodiment.

FIG. 7 is a diagram of a data analysis network according to an embodiment.

FIG. 8 is a diagram of a concatenated source feature map.

FIG. 9 is a block diagram of an information processing unit according to an embodiment.

### DESCRIPTION OF EMBODIMENT

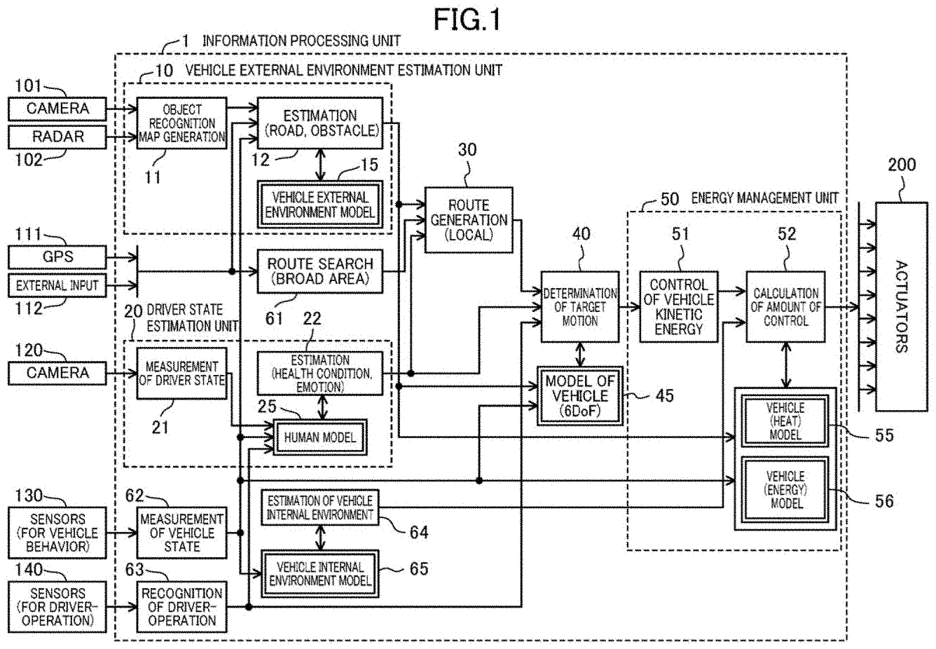

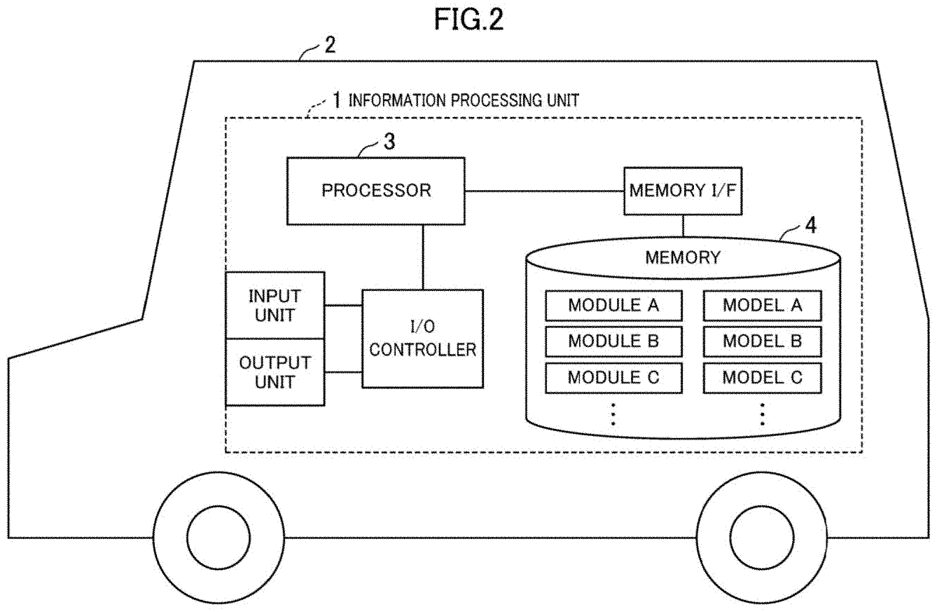

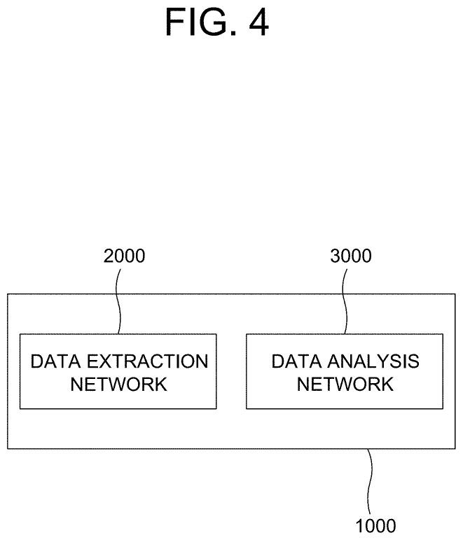

FIG. 1 is a block diagram illustrating a functional configuration of a vehicle arithmetic system according to an embodiment. FIG. 2 illustrates an exemplary configuration of an information processing unit. As shown in FIGS. 1 and 2, a vehicle arithmetic system includes an information processing unit 1 mounted in a vehicle 2. The information processing unit 1 receives various signals and data related to the vehicle 2 as an input. Based on these signals and data, the information processing unit 1 executes arithmetic processing, using a learned model generated by, for example, deep learning, thereby determining a target motion of the vehicle 2. Non-limiting examples of different approaches for developing the trained models is described with respect to FIGS. 4-8, discussed below. Then, based on the target motion determined, the information processing unit 1 generates control signals for actuators 200 of the vehicle 2. In other words, instead of separate controllers for each of the actuators, the information processing unit 1 according to embodiments may control all of the actuators. Thus, all of the information regarding the state of the vehicle and driver may be considered in an integrated manner and the actuators controlled accordingly. While individual engine control units may be provided for each actuator, the operation of these engine control units is controlled by the information processing unit 1.

As will be described in detail below, the information processing unit 1 may include a vehicle external environment estimation unit 10 (as further described in U.S. application Ser. No. 17/120,292 filed Dec. 14, 2020, and U.S. application Ser. No. 17/160,426 filed Jan. 28, 2021, the entire contents of each of which being incorporated herein by reference), a driver state estimation unit 20 (as further described in U.S. application Ser. No. 17/103,990 filed Nov. 25, 2020, the entire contents of which being incorporated herein by reference), a route generation unit 30 (as further described in more detail in U.S. application Ser. No. 17/161,691, filed 29 January. 2021, U.S. application Ser. No. 17/161,686, filed 29 Jan. 2021, and U.S. application Ser. No. 17/161,683, the entire contents of each of which being incorporated herein by reference), a target motion determination unit 40 (as further described in more detail in U.S. application Ser. No. 17/159,178, filed Jan. 27, 2021, the entire contents of which being incorporated herein by reference), a six degrees of freedom (6DoF) model of the vehicle 45 (as further described in more detail in U.S. application Ser. No. 17/159,175, filed Jan. 27, 2021, the entire contents of which being incorporated herein by reference), an energy management unit 50 (as further described in more detail in U.S. application Ser. No. 17/159,178, supra), a route search unit 61 (as further described in more detail in U.S. application Ser. No. 17/159,178, supra), a vehicle state measurement unit 62 (as further described in PCT application WO2020184297A1 filed Mar. 3, 2020, the entire contents of which being incorporated herein by reference), a driver operation recognition unit 63 (as further described in U.S. application Ser. No. 17/160,426 filed Jan. 28, 2021, the entire contents of which being incorporated herein by reference), a vehicle internal environment estimation unit 64 (as further described in U.S. application Ser. No. 17/156,631 filed Jan. 25, 2021, the entire contents of which being incorporated herein by reference), and a vehicle internal environment model 65 (which is adapted according to an external model development process like that discussed in U.S. application Ser. No. 17/160,426, supra). That is, the information processing unit 1 configured as a single piece of hardware, or a plurality of networked processing resources, achieves functions of estimating the vehicle external environment, generating the route, and determining the target motion.

In the exemplary configuration of FIG. 2, the information processing unit 1 includes a processor 3 and a memory 4. The memory 4 stores modules which are each a software program executable by the processor 3. The function of each unit shown in FIG. 1 is achieved by the processor 3 executing the modules stored in the memory 4. In addition, the memory 4 stores data representing each model shown in FIG. 1. Note that a plurality of processors 3 and memories 4 may be provided.

The functions of the information processing unit 1 may be achieved with a single chip, or a plurality of chips. In a case of using a plurality of chips to achieve the functions, the plurality of chips may be mounted on the same substrate or may be mounted on separate substrates. In the present embodiment, the information processing unit 1 is configured in a single housing.

### Exemplary Input to Information Processing Unit

An input to the information processing unit 1 includes outputs from cameras, sensors, and switches mounted in the vehicle, and signals, data and the like from outside the vehicle. For example, the input may be: outputs from a camera 101, a radar 102, and the like mounted on the vehicle which are each an example of sensors for obtaining information of the environment outside the vehicle (hereinafter, referred to as vehicle external environment); signals 111 from a positioning system such as a GPS; data 112 such as navigation data transmitted from a vehicle-external network; an output from a camera 120 and the like installed inside the passenger compartment (an example of a sensor for obtaining information of the driver); outputs from sensors 130 configured to detect the behavior of the vehicle; and outputs from sensors 140 configured to detect driver-operations.

The camera 101 mounted on the vehicle captures images around the vehicle, and outputs image data representing the images captured. The radar 102 mounted on the vehicle sends out radio waves around the vehicle, and receives reflected waves from an object. Based on the waves transmitted and the waves received, the radar 102 measures the distance between the vehicle and the object and the relative speed of the object with respect to the vehicle. Note that other examples of sensors for obtaining information of the vehicle external environment include, for example, a laser radar, an ultrasonic sensor, and the like.

Examples of sensors for obtaining information of the driver, other than the camera 120 installed inside the passenger compartment, include bio-information sensors such as a skin temperature sensor, a heart beat sensor, a blood flow sensor, a perspiration sensor, and the like.

Examples of the sensors 130 for detecting the behavior of the vehicle includes a vehicle speed sensor, an acceleration sensor, a yaw rate sensor, and the like. Examples of the sensors 140 for detecting driver-operation include a steering angle sensor, an accelerator sensor, a brake sensor, and the like.

### Exemplary Output from Information Processing Unit

The information processing unit 1 outputs control signals to controllers configured to control actuators 200 of the vehicle. Examples of the controllers include an engine controller, a brake controller, a steering controller, and the like. The controllers are implemented in the form of, for example, an electronic control unit (ECU). The information processing unit 1 and the ECU are connected via an on-board network such as a controller area network (CAN). The output control signals may be uniquely assigned to a particular controller, or in other instances may be a common control signal that is addressed to multiple controllers. In this later case, the common output control signal is interpreted by the first controller to perform a function (e.g., actuate the throttle according to a predetermined force/time distribution), but also interpreted by the steering controller to actuate the steering system in concert with the application of the throttle. Because the information processing unit 1 performs the route planning and determines the specific operations to be performed by different units, it is possible for the information processing unit 1 to send a combined command to selected of the respective units to execute operations in a coordinated way. For example, by deciding a route plan for the vehicle, the information processing unit 1 may determine that the vehicle should change lanes, and based on a detected external obstacle, the vehicle should accelerate while changing lanes. The information processing unit 1 can then issue a common command (or separate commands with time profiles) to a throttle controller and a steering controller. The time profile for the throttle controller recognizes any lag in developed engine power to provide the needed acceleration at the time of making the steering change. Thus, the force exerted by the throttle controller on the throttle anticipates the extra power needed when the steering system changes lanes so the engine provides sufficient propulsion power the moment it is needed. Similar combined commands may be used during other maneuvers involving brakes, external/internal detected events, driver state, energy management, vehicle state, driver operation and the like.

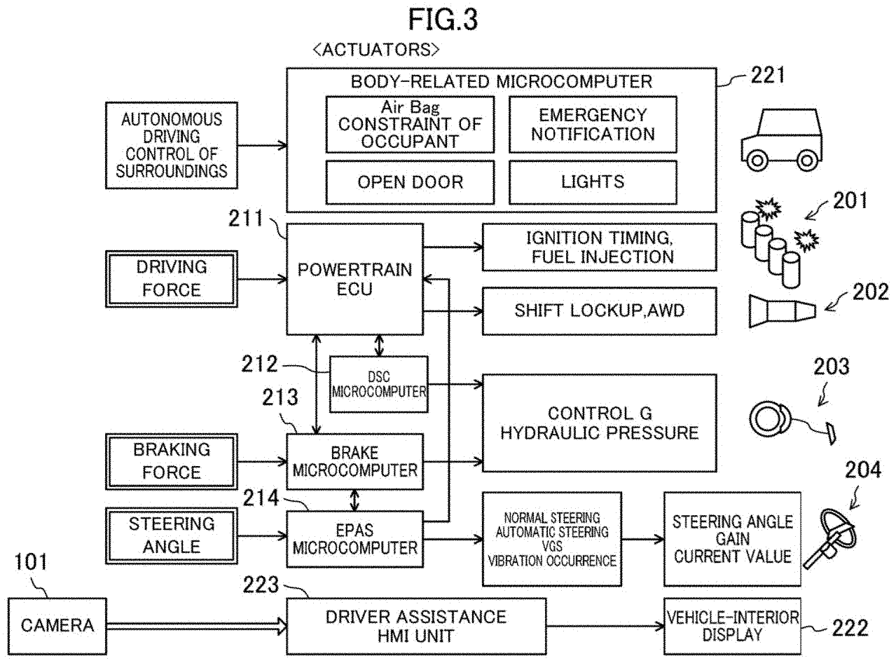

FIG. 3 shows specific examples of the actuators. In FIG. 3, the reference numeral 201 denotes the engine; the reference numeral 202 denotes a transmission; the reference numeral 203 denotes the brake; and the reference numeral 204 denotes the steering wheel. A powertrain ECU 211, a dynamic stability control (DSC) microcomputer 212, a brake microcomputer 213, an electric power assist steering (EPAS) microcomputer 214 are examples of controllers.

The information processing unit 1 calculates a driving force, a braking force, and a steering angle of the vehicle to achieve a target motion determined. For example, the powertrain ECU 211 controls the ignition timing and the amount of fuel injection in the engine 201, according to the driving force calculated, if the engine is an internal combustion engine. The EPAS microcomputer 214 controls the steering by the steering wheel 204, according to the steering angle calculated.

Note that examples of controllers controlling other actuators include a body-related microcomputer 221 configured to perform controls related to the body, such as an airbag and doors, a driver assistance human machine interface (HMI) unit 223 configured to control vehicle-interior display 222, and the like.

The functional configuration of the information processing unit 1 shown in FIG. 1 will be described in detail. The information processing unit 1 performs so-called model prediction control (MPC) in, for example, a route generating process and the like. To put it simply, the model predictive control involves an evaluation function for yielding a multivariate output with a multivariate input, and solving this function with a convex function (multivariate analysis: a mathematical approach to efficiently solve multivariate problems) to extract a well-balanced outcome. A relational expression (referred to as a model) for obtaining a multivariate output from a multivariate input is first created by a designer based on a physical phenomenon of an object. Then, the relational expression is evolved by neural learning (so-called unsupervised learning). Alternatively, the relational expression is evolved by tuning the relational expression in view of statistics of the inputs and outputs.

At the time of shipment of the vehicle, a model developed by a manufacturer is implemented. Then, the implemented model may evolve to a model suitable for a user, according to how the user drives the vehicle. Alternatively, the model may be updated by an update program distributed by a dealer or the like.

Outputs from the camera 101 and the radar 102 mounted on the vehicle are sent to a vehicle external environment estimation unit 10. Signals 111 of the positioning system such as the GPS and the data 112 (e.g., for navigation) transmitted from the vehicle-external network are transmitted to a route search unit 61. An output of the camera 120 in the passenger compartment is sent to a driver state estimation unit 20. Outputs of the sensors 130 which detect the behavior of the vehicle are sent to a vehicle state measurement unit 62. Outputs of the sensors 140 which detect driver-operations are sent to a driver operation recognition unit 63.

### Vehicle External Environment Estimation Unit

The vehicle external environment estimation unit 10 receives the outputs of the cameras 101 and the radars 102 mounted on the vehicle and estimates the vehicle external environment. The vehicle external environment to be estimated includes at least a road and an obstacle. In this example, the vehicle external environment estimation unit 10 estimates the environment of the vehicle including a road and an obstacle by comparing the 3-dimensional information of the surroundings of the vehicle with a vehicle external environment model 15 based on the data obtained by the cameras 101 and the radars 102. The vehicle external environment model 15 is, for example, a learned model generated by deep learning, and allows recognition of a road, an obstacle, or the like with respect to the 3-dimensional information of the surroundings of the vehicle.

For example, an object recognition/map generation unit 11 identifies a free space, that is, an area without an object, by processing images taken by the cameras 101. In this image processing, for example, a learned model generated by deep learning is used. Then, a 2-dimensional map representing the free space is generated. In addition, the object recognition/map generation unit 11 obtains information of a target around the vehicle from outputs of the radars 102. This information includes the position, the speed, and the like of the target.

An estimation unit 12 generates a 3-dimensional map representing the surroundings of the vehicle by combining the 2-dimensional map output from the object recognition/map generation unit 11 and the information on the target. This process uses information of the installation positions and shooting directions of the cameras 101, and information of the installation positions and the transmission direction of the radars 102. The estimation unit 12 then compares the 3-dimensional map generated with the vehicle external environment model 15 to estimate the environment of the vehicle including the road and the obstacle.

### Driver State Estimation Unit

The driver state estimation unit 20 estimates a health condition, an emotion, or a physical behavior of the driver from an image captured by the camera 120 installed in the passenger compartment. Examples of the health condition include good health condition, slightly fatigue, poor health condition, decreased consciousness, and the like. Examples of the emotion include fun, normal, bored, annoyed, uncomfortable, and the like.

For example, a driver state measurement unit 21 extracts a face image of the driver from an image captured by the camera 120 installed in the passenger compartment, and identifies the driver. The extracted face image and information of the identified driver are provided as inputs to a human model 25. The human model 25 is a learned model generated by deep learning, for example, and outputs the health condition and the emotion of each person who may be the driver of the vehicle, based on the face image. The estimation unit 22 outputs the health condition and the emotion of the driver output by the human model 25. Details of such estimation are disclosed in U.S. Pat. No. 10,576,989, which entire contents of which is hereby incorporated by reference.

In addition, in a case of adopting a bio-information sensor, such as a skin temperature sensor, a heart beat sensor, a blood flow sensor, a perspiration sensor, as a means for acquiring information of the driver, the driver state measurement unit 21 measures the bio-information of the driver from the output from the bio-information sensor. In this case, the human model 25 receives the bio-information as inputs, and outputs the health conditions and the emotions of each person who may be the driver of the vehicle. The estimation unit 22 outputs the health condition and the emotion of the driver output by the human model 25.

In addition, as the human model 25, a model that estimates an emotion of a human in relation to the behavior of the vehicle may be used for each person who may be the driver of the vehicle. In this case, the model may be constructed by managing, in time sequence, the outputs of sensors 130 which detect the behavior of the vehicle, the outputs of the sensors 140 which detect the driver-operations, the bio-information of the driver, and the estimated emotional states. With this model, for example, it is possible to predict the relationship between changes in the driver's emotion (the degree of wakefulness) and the behavior of the vehicle.

In addition, the driver state estimation unit 20 may include a human body model as the human model 25. The human body model specifies, for example, the weight of the head (e.g., 5 kg) and the strength of the muscles around the neck supporting against G-forces in the front, back, left, and right directions. The human body model outputs predicted physical and subjective properties of the occupant, when a motion (acceleration G-force or jerk) of the vehicle body is input. The physical property of the occupant is, for example, comfortable/moderate/uncomfortable, and the subjective property is, for example, unexpected/predictable. For example, a vehicle behavior that causes the head to lean backward even slightly is uncomfortable for an occupant. Therefore, a traveling route that causes the head to lean backward can be avoided by referring to the human body model. On the other hand, a vehicle behavior that causes the head of the occupant to lean forward in a bowing manner does not immediately lead to discomfort. This is because the occupant is easily able to resist such a force. Therefore, such a traveling route that causes the head to lean forward may be selected. Alternatively, by referring to the human body model, a target motion can be determined, for example, so that the head of the occupant does not swing, or determined dynamically so that the occupant feels lively.

### Route Search Unit

The route search unit 61 searches for a wide-area route of the vehicle using the signals 111 of the positioning system such as the GPS or the data 112 (e.g. for car navigation) transmitted from the vehicle-external network.

### Vehicle State Measurement Unit

The vehicle state measurement unit 62 measures a state of the vehicle, from the outputs of sensors 130 which detect the behavior of the vehicle, such as a vehicle speed sensor, an acceleration sensor, and a yaw rate sensor. Then, a vehicle internal environment model 65 representing the internal environment of the vehicle (hereinafter, vehicle internal environment) is generated. The vehicle internal environment includes physical quantities, such as humidity, temperature, shaking, vibration, and acoustic noise, which particularly physically affect the occupant. A vehicle internal environment estimation unit 64 estimates and outputs the vehicle internal environment based on the vehicle internal environment model 65.

### Driver Operation Recognition Unit

The driver operation recognition unit 63 recognizes driver-operations through outputs of the sensors 140, such as the steering angle sensor, the accelerator sensor, and the brake sensor, which detect driver-operations.

### Route Generation Unit

A route generation unit 30 generates a traveling route of the vehicle based on the outputs from the vehicle external environment estimation unit 10 and the outputs from the route search unit 61. Details of the route generation unit 30 may be found, e.g., in co-pending U.S. application Ser. No. 17/123,116, the entire contents of which is hereby incorporated by reference. For example, the route generation unit 30 generates a traveling route that avoids an obstacle estimated by the vehicle external environment estimation unit 10, on the road estimated by the vehicle external environment estimation unit 10. The outputs of the vehicle external environment estimation unit 10 include, for example, travel road information related to the road traveled by the vehicle. The travel road information includes information relating to the shape of the travel road itself and information relating to objects on the travel road. The information relating to the shape of the travel road includes the shape of the travel road (whether it is straight or curved, and the curvature), the width of the travel road, the number of lanes, the width of each lane, and so on. The information related to the object includes a relative position and a relative speed of the object with respect to the vehicle, an attribute (e.g., a type, a moving direction) of the object, and so on. Examples of the type of the object include a vehicle, a pedestrian, a road, a section line, and the like.

Here, it is assumed that the route generation unit 30 calculates a plurality of route candidates by means of a state lattice method, and selects one or more route candidates from among these route candidates based on a route cost of each route candidate. However, the routes may be generated by means of a different method.

The route generation unit 30 sets a virtual grid area on the travel road based on the travel road information. The grid area has a plurality of grid points. With the grid points, a position on the travel road is specified. The route generation unit 30 sets a predetermined grid point as a target reach position, by using the output from the route search unit 61. Then, a plurality of route candidates are calculated by a route search involving a plurality of grid points in the grid area. In the state lattice method, a route branches from a certain grid point to random grid points ahead in the traveling direction of the vehicle. Thus, each route candidate is set to sequentially pass through the plurality of grid points. Each route candidate includes time information indicating the time of passing each grid point, speed information related to the speed, acceleration, and the like at each grid point, and information related to other vehicle motion, and the like.

The route generation unit 30 selects one or more traveling routes from the plurality of route candidates based on the route cost. The route cost described herein includes, for example, the lane-centering degree, the acceleration of the vehicle, the steering angle, the possibility of collision, and the like. Note that, when the route generation unit 30 selects a plurality of traveling routes, a later-described target motion determination unit 40 and a later-described energy management unit 50 select one of the traveling routes.

### Target Motion Determination Unit

The target motion determination unit 40 determines a target motion for the traveling route selected by the route generation unit 30. The target motion means steering and acceleration/deceleration for tracing the traveling route. In addition, with reference to the 6DoF model 45 of the vehicle, the target motion determination unit 40 calculates the motion of the vehicle body on the traveling route selected by the route generation unit 30.

Here, the 6DoF model 45 of the vehicle is obtained by modeling acceleration along three axes, namely, in the “forward/backward (surge),” “left/right (sway),” and “up/down (heave)” directions of the traveling vehicle, and the angular velocity along the three axes, namely, “pitch,” “roll,” and “yaw.” That is, the 6DoF model 45 of the vehicle is a numerical model that not only includes the vehicle motion on the plane (the forward/backward and left/right directions (i.e., the movement along the X-Y plane), and the yawing (along the Z-axis)) according to the classical vehicle motion engineering, but also reproduces the behavior of the vehicle using six axes in total. The vehicle motions along the six axes further include the pitching (along the Y-axis), rolling (along the X-axis) and the movement along the Z-axis (i.e., the up/down motion) of the vehicle body mounted on the four wheels with the suspension interposed therebetween.

In addition, with reference to the 6DoF model 45 of the vehicle, the target motion determination unit 40 calculates the motion of the vehicle body, and uses the calculation result to determine the target motion. That is, the target motion determination unit 40 estimates, by referring to the 6DoF model 45 of the vehicle, a planar motion of the vehicle and changes in a vehicle posture in the up/down directions which occur while the vehicle travels along the traveling route generated by the route generation unit 30, and determines the estimated planar motion of the vehicle and the changes in the vehicle posture in the up/down directions as the target motion of the vehicle. This makes it possible, for example, to generate a state of so-called diagonal roll during cornering.

Further, for example, the target motion determination unit 40 may input, to the human body model, the motion (acceleration G-force or jerk) of the vehicle body calculated by referring to the 6DoF model 45 of the vehicle and obtain predicted physical and subjective properties of the occupant. Then, for example, when the route generation unit 30 selects a plurality of traveling routes, the target motion determination unit 40 may select one of the traveling routes, based on the predicted physical and subjective properties of the occupant.

In addition, when the driver-operation is recognized by the driver operation recognition unit 63, the target motion determination unit 40 determines a target motion according to the driver-operation, and does not follow the traveling route selected by the route generation unit 30.

### Energy Management Unit

The energy management unit 50 calculates a driving force, a braking force, and a steering angle to achieve the target motion determined by the target motion determination unit 40. Then, control signals are generated for each actuator 200 so as to achieve the calculated driving force, the braking force, and the steering angle.

For example, a vehicle kinetic energy control unit 51 calculates physical quantities such as a torque required for the drive system (engine, motor, transmission), the steering system (steering wheel), and the braking system (brake) with respect to the target motion determined by the target motion determination unit 40. A control amount calculation unit 52 calculates a control amount for each actuator so that the target motion determined by the target motion determination unit 40 is achievable at the highest energy efficiency. Specifically, for example, the timing of opening and closing intake/exhaust valves, the timing of injecting the fuel from injectors, and the like are calculated so as to yield a most improved fuel efficiency while achieving the engine torque determined by the vehicle kinetic energy control unit 51. The energy management described herein uses a vehicle heat model 55 or a vehicle energy model 56. For example, each of the calculated physical quantities is compared with the vehicle energy model 56 and the kinetic quantity is distributed to each actuator so that the energy consumption is reduced.

Specifically, for example, the energy management unit 50 calculates, based on the target motion determined by the target motion determination unit 40, a motion condition that minimizes the energy loss for the traveling route selected by the route generation unit 30. For example, the energy management unit 50 calculates a traveling resistance of the vehicle for the traveling route selected by the route generation unit 30, and obtains the loss on the route. The traveling resistance includes tire friction, a drive system loss, and air resistance. Then, a driving condition is obtained to generate a driving force required to overcome the loss. Examples of the driving condition obtained includes the injection timing and the ignition timing which minimizes the fuel consumption in the internal combustion engine, a shifting pattern which leads to a small energy loss in the transmission, a lockup control of the torque control. Alternatively, in a case where deceleration is required, a combination of a foot brake and an engine brake of the vehicle model that achieves a deceleration profile and a regenerative model of a drive assisting motor is calculated, and a motion condition that minimizes the energy loss is determined.

Then, the energy management unit 50 generates a control signal for each actuator 200 according to the motion condition determined, and outputs the control signal to the controller of each actuator 200.

As described hereinabove, in a vehicle arithmetic system of the present embodiment, the information processing unit 1 includes a vehicle external environment estimation unit 10 configured to receive outputs from sensors that obtain information of a vehicle external environment, and estimate the vehicle external environment; a route generation unit 30 configured to generate a route of the vehicle, based on the output from the vehicle external environment estimation unit 10; and a target motion determination unit 40 configured to determine a target motion of the vehicle based on an output from the route generation unit 30. That is, the information processing unit 1 configured as a single piece of hardware achieves functions of estimating the vehicle external environment, generating the route, and determining the target motion. Details of the energy management unit 50 may be found, e.g., in co-pending U.S. application Ser. No. 17/159,175, the entirety of which is hereby incorporated by reference.

This enables high-speed data transmission among the functions, and suitable control of the entire functions. For example, in a case where the functions are separate ECUs, communication among the ECUs is needed to transmit or receive a large volume of data among the functions. However, the communication speed of the currently used on-board network (CAN, Ethernet (registered trademark)) is approximately 2 Mbps to 100 Mbps. To the contrary, the information processing unit 1 configured as a single piece of hardware allows a data transmission rate of several Gbps to several tens of Gbps.

Thus, centralizing processes for the autonomous driving in a single information processing unit 1 enables highly accurate autonomous driving.

In addition, the information processing unit 1 of the present embodiment further includes an energy management unit 50. That is, it is possible not only to estimate the vehicle external environment, generate the route, and determine the target motion with the information processing unit 1 configured as a single piece of hardware, but also to manage energy with the information processing unit. Therefore, highly accurate autonomous driving, which takes into account the vehicle behavior and energy consumption, is possible by centralizing processes for the autonomous driving in the single information processing unit 1.

### Examples of Other Controls

The route generation unit 30 may generate a traveling route of the vehicle by using an output from the driver state estimation unit 20. For example, the driver state estimation unit 20 may output data representing the emotion of the driver to the route generation unit 30, and the route generation unit 30 may select a traveling route by using the data representing the emotion. For example, when the emotion is “fun,” a route that causes a smooth behavior of the vehicle is selected, and when the emotion is “bored,” a route that causes a largely varying behavior of the vehicle is selected.

Alternatively, the route generation unit 30 may refer to the human model 25 of the driver state estimation unit 20, and select a route that changes the driver's emotion (raises the degree of wakefulness) out of a plurality of route candidates.

In addition, the route generation unit 30, when it is determined that the vehicle is in danger based on the vehicle external environment estimated by the vehicle external environment estimation unit 10, may generate an emergency route for avoiding the danger, irrespective of the state of the driver. In addition, the route generation unit 30 may generate a route for evacuating the vehicle to a safe place, when it is determined that the driver is unable to drive or having a difficulty to drive (e.g., when the driver is unconscious) based on the output from the driver state estimation unit 20.

In addition, the target motion determination unit 40 may determine the target motion so as to evacuate the vehicle to a safe place, when it is determined that the driver is unable to drive or having a difficulty to drive (e.g., when the driver is unconscious) based on the output from the driver state estimation unit 20. The configuration, in this case, may be such that the route generation unit 30 generates a plurality of traveling routes including a route for evacuating the vehicle to a safe place, and that the target motion determination unit 40 selects (override) a route for evacuating the vehicle to a safe place when it is determined that the driver is unable to drive or having a difficulty to drive.

In a non-limiting example, a process is described about how a learned model is trained, according to the present teachings. The example will be in the context of a vehicle external environment estimation circuitry (e.g., a trained model saved in a memory and applied by a computer). However, other aspects of the trained model for controlling steering, braking, etc., are implemented in a similar processes. Hereinafter, as part of a process for determining how a computing device 1000 calculates a route path (R2, R13, R12, or R11 for example on a road 5) in the presence of an obstacle 3 (another vehicle) surrounded by a protection zone (see dashed line that encloses unshaded area) will be explained. In this example, the obstacle 3 is a physical vehicle that has been captured by a forward looking camera from the trailing vehicle 1. The model is hosted in a single information processing unit (or single information processing circuitry).

First, by referring to FIG. 4, a configuration of a computing device 1000 will be explained.

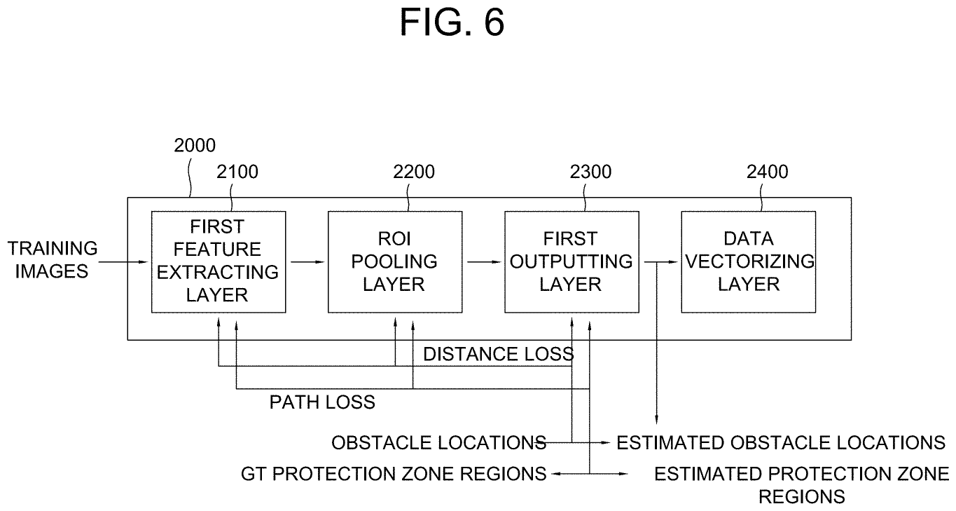

The computing device 1000 may include a data extraction network 2000 and a data analysis network 3000. Further, to be illustrated in FIG. 6, the data extraction network 2000 may include at least one first feature extracting layer 2100, at least one Region-Of-Interest(ROI) pooling layer 2200, at least one first outputting layer 2300 and at least one data vectorizing layer 2400. And, also to be illustrated in FIG. 4, the data analysis network 3000 may include at least one second feature extracting layer 3100 and at least one second outputting layer 3200. Below, an aspect of calculating a safe route (e.g. R13), around a protection zone that surrounds the obstacle will be explained. Moreover, the specific aspect is to learn a model to detect obstacles (e.g., vehicle 1) on a roadway, and also estimate relative distance to a superimposed protection range that has been electronically superimposed about the vehicle 3 in the image. To begin with, a first embodiment of the present disclosure will be presented.

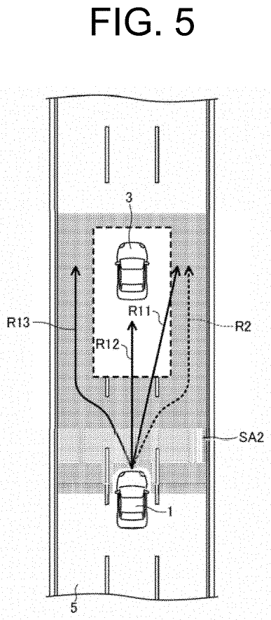

First, the computing device 1000 may acquire at least one subject image that includes a superimposed protection zone about the subject vehicle 3. By referring to FIG. 5, the subject image may correspond to a scene of a highway, photographed from a vehicle 1 that is approaching another vehicle 3 from behind on a three lane highway.

After the subject image is acquired, in order to generate a source vector to be inputted to the data analysis network 3000, the computing device 1000 may instruct the data extraction network 2000 to generate the source vector including (i) an apparent distance, which is a distance from a front of vehicle 1 to a back of the protection zone surrounding vehicle 3, and (ii) an apparent size, which is a size of the protection zone.

In order to generate the source vector, the computing device 1000 may instruct at least part of the data extraction network 2000 to detect the obstacle 3 (vehicle) and protection zone. Specifically, the computing device 1000 may instruct the first feature extracting layer 2100 to apply at least one first convolutional operation to the subject image, to thereby generate at least one subject feature map. Thereafter, the computing device 1000 may instruct the ROI pooling layer 2200 to generate one or more ROI-Pooled feature maps by pooling regions on the subject feature map, corresponding to ROIs on the subject image which have been acquired from a Region Proposal Network (RPN) interworking with the data extraction network 2000. And, the computing device 1000 may instruct the first outputting layer 2300 to generate at least one estimated obstacle location and one estimated protection zone region. That is, the first outputting layer 2300 may perform a classification and a regression on the subject image, by applying at least one first Fully-Connected (FC) operation to the ROI-Pooled feature maps, to generate each of the estimated obstacle location and protection zone region, including information on coordinates of each of bounding boxes. Herein, the bounding boxes may include the obstacle and a region around the obstacle (protection zone).

After such detecting processes are completed, by using the estimated obstacle location and the estimated protection zone location, the computing device 1000 may instruct the data vectorizing layer 2400 to subtract a y-axis coordinate (distance in this case) of an upper bound of the obstacle from a y-axis coordinate of the closer boundary of the protection zone to generate the apparent distance, and multiply a distance of the protection zone and a horizontal width of the protection zone to generate the apparent size of the protection zone. The apparent distance may be different than the actual distance, for example if the camera is mounted low on the vehicle, but the obstacle (perhaps a ladder strapped to a roof of the vehicle 3) is at an elevated height, the different in the Y direction should be realized/detected in order to identify an actual distance to the object.

After the apparent distance and the apparent size are acquired, the computing device 1000 may instruct the data vectorizing layer 2400 to generate at least one source vector including the apparent distance and the apparent size as its at least part of components.

Then, the computing device 1000 may instruct the data analysis network 3000 to calculate an estimated actual protection zone by using the source vector. Herein, the second feature extracting layer 3100 of the data analysis network 3000 may apply second convolutional operation to the source vector to generate at least one source feature map, and the second outputting layer 3200 of the data analysis network 3000 may perform a regression, by applying at least one FC operation to the source feature map, to thereby calculate the estimated protection zone.

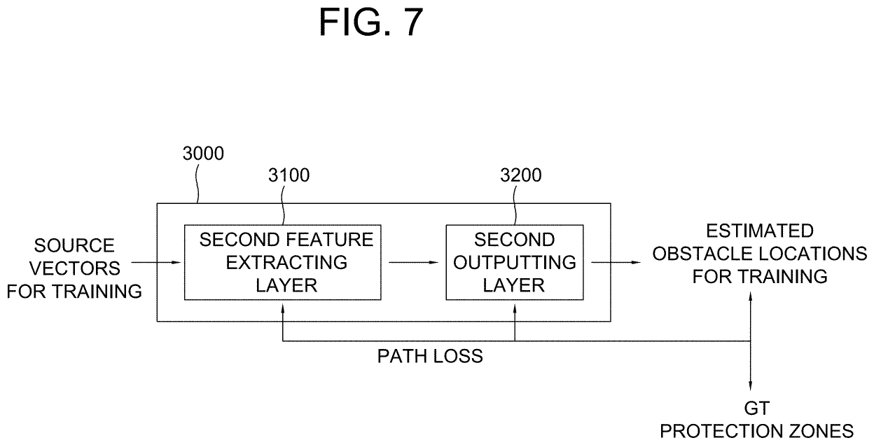

As shown above, the computing device 1000 may include two neural networks, i.e., the data extraction network 2000 and the data analysis network 3000. The two neural networks should be trained to perform the processes properly, and thus below it is described how to train the two neural networks by referring to FIG. 6 and FIG. 7.

First, by referring to FIG. 6, the data extraction network 2000 may have been trained by using (i) a plurality of training images corresponding to scenes of subject roadway conditions for training, photographed from fronts of the subject vehicles for training, including images of their corresponding projected protection zones (protection zones superimposed around a forward vehicle, or perhaps a forward vehicle with a ladder strapped on top of it, which is an “obstacle” on a roadway) for training and images of their corresponding grounds for training, and (ii) a plurality of their corresponding ground truth (GT) obstacle locations and GT protection zone regions. The protection zones do not occur naturally, but are previously superimposed about the vehicle 3 via another process, perhaps a bounding box by the camera. More specifically, the data extraction network 2000 may have applied aforementioned operations to the training images, and have generated their corresponding estimated obstacle locations and estimated protection zone regions. Then, (i) each of obstacle pairs of each of the estimated obstacle locations and each of their corresponding GT obstacle locations and (ii) each of obstacle pairs of each of the estimated protection zone locations associated with the obstacles and each of the GT protection zone locations may have been referred to, in order to generate at least one vehicle path loss and at least one distance, by using any of loss generating algorithms, e.g., a smooth-L1 loss algorithm and a cross-entropy loss algorithm. Thereafter, by referring to the distance loss and the path loss, backpropagation may have been performed to learn at least part of parameters of the data extraction network 2000. Parameters of the RPN can be trained also, but a usage of the RPN is a well-known prior art, thus further explanation is omitted.

Herein, the data vectorizing layer 2400 may have been implemented by using a rule-based algorithm, not a neural network algorithm. In this case, the data vectorizing layer 2400 may not need to be trained, and may just be able to perform properly by using its settings inputted by a manager.

As an example, the first feature extracting layer 2100, the ROI pooling layer 2200 and the first outputting layer 2300 may be acquired by applying a transfer learning, which is a well-known prior art, to an existing object detection network such as VGG or ResNet, etc.

Second, by referring to FIG. 7, the data analysis network 3000 may have been trained by using (i) a plurality of source vectors for training, including apparent distances for training and apparent sizes for training as their components, and (ii) a plurality of their corresponding GT protection zones. More specifically, the data analysis network 3000 may have applied aforementioned operations to the source vectors for training, to thereby calculate their corresponding estimated protection zones for training. Then each of distance pairs of each of the estimated protection zones and each of their corresponding GT protection zones may have been referred to, in order to generate at least one distance loss, by using said any of loss algorithms. Thereafter, by referring to the distance loss, backpropagation can be performed to learn at least part of parameters of the data analysis network 3000.

After performing such training processes, the computing device 1000 can properly calculate the estimated protection zone by using the subject image including the scene photographed from the front of the subject roadway and applying to the trained model. The output of the model can then be used by the information processing unit 1 to detect the external environment, perform route planning and then dispatch one or more control signals to the controllers to operate the various actuators that control the vehicle's motion on a manner consistent with the planned route.

Hereafter, another embodiment will be presented. A second embodiment is similar to the first embodiment, but different from the first embodiment in that the source vector thereof further includes a tilt angle, which is an angle between an optical axis of a camera which has been used for photographing the subject image (e.g., the subject obstacle) and a distance to the obstacle. Also, in order to calculate the tilt angle to be included in the source vector, the data extraction network of the second embodiment may be slightly different from that of the first one. In order to use the second embodiment, it should be assumed that information on a principal point and focal lengths of the camera are provided.

Specifically, in the second embodiment, the data extraction network 2000 may have been trained to further detect lines of a road in the subject image, to thereby detect at least one vanishing point of the subject image. Herein, the lines of the road may denote lines representing boundaries of the road located on the obstacle in the subject image, and the vanishing point may denote where extended lines generated by extending the lines of the road, which are parallel in the real world, are gathered. As an example, through processes performed by the first feature extracting layer 2100, the ROI pooling layer 220 and the first outputting layer 2300, the lines of the road may be detected.

After the lines of the road are detected, the data vectorizing layer 240 may find at least one point where the most extended lines are gathered, and determine it as the vanishing point. Thereafter, the data vectorizing layer 2400 may calculate the tilt angle by referring to information on the vanishing point, the principal point and the focal lengths of the camera by using a following formula:

θₜᵢₗₜ=α tan 2(vy−cy, fy)

In the formula, vy may denote a y-axis (distance direction) coordinate of the vanishing point, cy may denote a y-axis coordinate of the principal point, and fy may denote a y-axis focal length. Using such formula to calculate the tilt angle is a well-known prior art, thus more specific explanation is omitted.

After the tilt angle is calculated, the data vectorizing layer 2400 may set the tilt angle as a component of the source vector, and the data analysis network 3000 may use such source vector to calculate the estimated protection zone. In this case, the data analysis network 3000 may have been trained by using the source vectors for training additionally including tilt angles for training.

For a third embodiment which is mostly similar to the first one, some information acquired from a subject obstacle database (DB) storing information on subject obstacles, including the subject obstacle, can be used for generating the source vector. That is, the computing device 1000 may acquire structure information on a structure of the subject vehicle, e.g., 4 doors, vehicle base length of a certain number of feet, from the subject vehicle DB. Or, the computing device 1000 may acquire topography information on a topography of a region around the subject vehicle, e.g., hill, flat, bridge, etc., from location information for the particular roadway. Herein, at least one of the structure information and the topography information can be added to the source vector by the data vectorizing layer 2400, and the data analysis network 3000, which has been trained by using the source vectors for training additionally including corresponding information, i.e., at least one of the structure information and the topography information, may use such source vector to calculate the estimated protection zone.

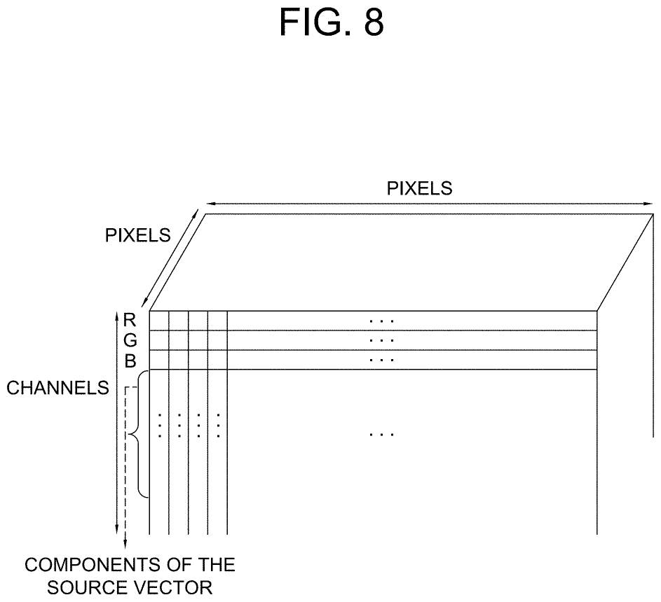

As a fourth embodiment, the source vector, generated by using any of the first to the third embodiments, can be concatenated channel-wise to the subject image or its corresponding subject segmented feature map, which has been generated by applying an image segmentation operation thereto, to thereby generate a concatenated source feature map, and the data analysis network 3000 may use the concatenated source feature map to calculate the estimated protection zone. An example configuration of the concatenated source feature map may be shown in FIG. 8. In this case, the data analysis network 3000 may have been trained by using a plurality of concatenated source feature maps for training including the source vectors for training, other than using only the source vectors for training. By using the fourth embodiment, much more information can be inputted to processes of calculating the estimated protection zone, thus it can be more accurate. Herein, if the subject image is used directly for generating the concatenated source feature map, it may require too much computing resources, thus the subject segmented feature map may be used for reducing a usage of the computing resources.

Descriptions above are explained under an assumption that the subject image has been photographed from the back of the subject vehicle, however, embodiments stated above may be adjusted to be applied to the subject image photographed from other sides of the subject vehicle. And such adjustment will be easy for a person in the art, referring to the descriptions.

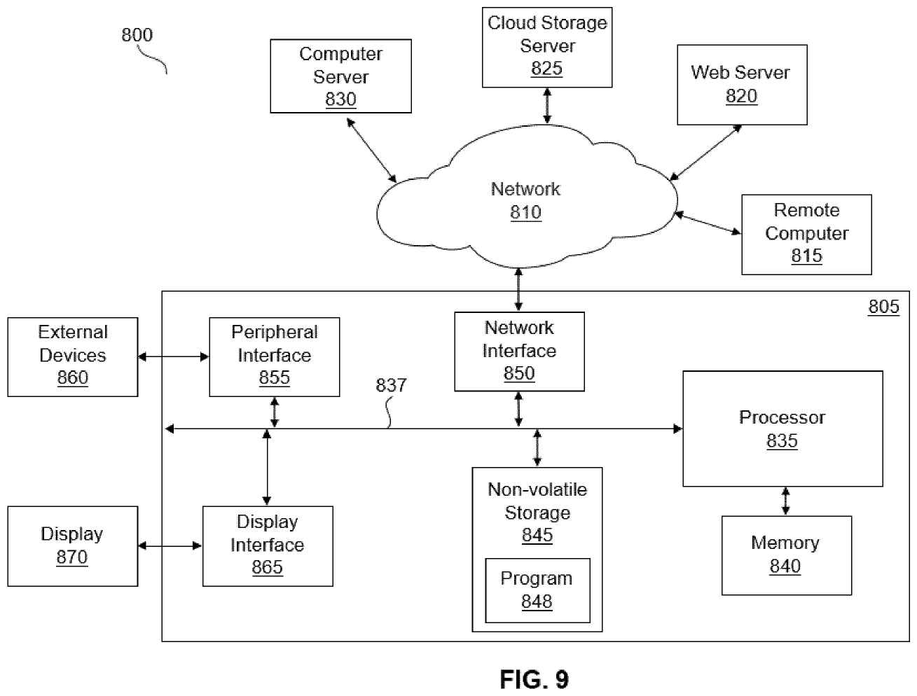

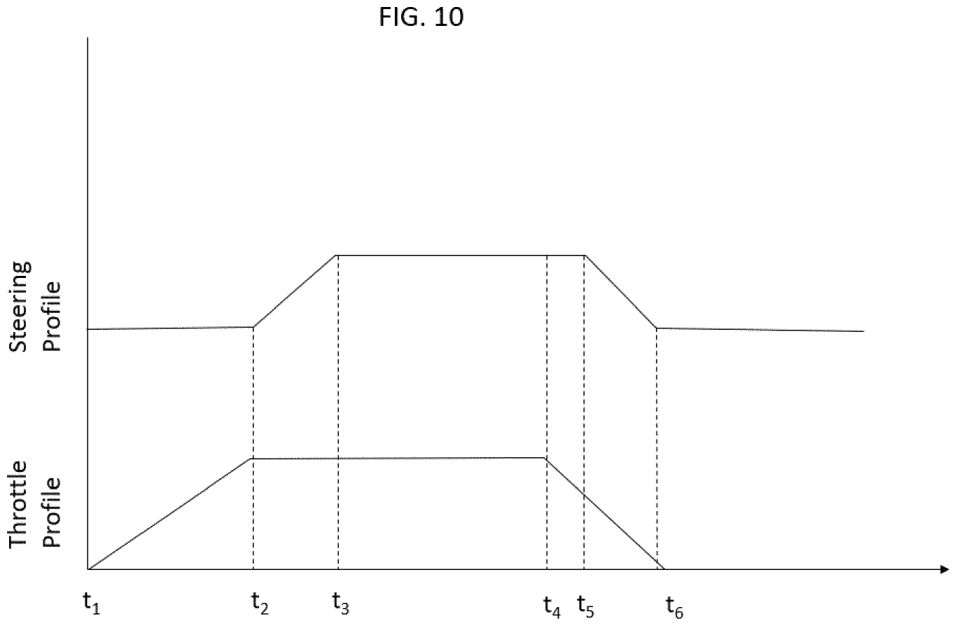

FIG. 9 illustrates a block diagram of a computer that may implement the functions of the information processing unit 1 described herein.

The present disclosure may be embodied as a system, a method, and/or a computer program product. The computer program product may include a computer readable storage medium on which computer readable program instructions are recorded that may cause one or more processors to carry out aspects of the embodiments.

The computer readable storage medium may be a tangible device that can store instructions for use by an instruction execution device (processor). The computer readable storage medium may be, for example, but is not limited to, an electronic storage device, a magnetic storage device, an optical storage device, an electromagnetic storage device, a semiconductor storage device, or any appropriate combination of these devices. A non-exhaustive list of more specific examples of the computer readable storage medium includes each of the following (and appropriate combinations): flexible disk, hard disk, solid-state drive (SSD), random access memory (RAM), read-only memory (ROM), erasable programmable read-only memory (EPROM or Flash), static random access memory (SRAM), compact disc (CD or CD-ROM), digital versatile disk (DVD) and memory card or stick. A computer readable storage medium, as used in this disclosure, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described in this disclosure can be downloaded to an appropriate computing or processing device from a computer readable storage medium or to an external computer or external storage device via a global network (i.e., the Internet), a local area network, a wide area network and/or a wireless network. The network may include copper transmission wires, optical communication fibers, wireless transmission, routers, firewalls, switches, gateway computers and/or edge servers. A network adapter card or network interface in each computing or processing device may receive computer readable program instructions from the network and forward the computer readable program instructions for storage in a computer readable storage medium within the computing or processing device.

Computer readable program instructions for carrying out operations of the present disclosure may include machine language instructions and/or microcode, which may be compiled or interpreted from source code written in any combination of one or more programming languages, including assembly language, Basic, Fortran, Java, Python, R, C, C++, C# or similar programming languages. The computer readable program instructions may execute entirely on a user's personal computer, notebook computer, tablet, or smartphone, entirely on a remote computer or computer server, or any combination of these computing devices. The remote computer or computer server may be connected to the user's device or devices through a computer network, including a local area network or a wide area network, or a global network (i.e., the Internet). In some embodiments, electronic circuitry including, for example, programmable logic circuitry, field-programmable gate arrays (FPGA), or programmable logic arrays (PLA) may execute the computer readable program instructions by using information from the computer readable program instructions to configure or customize the electronic circuitry, in order to perform aspects of the present disclosure.

Aspects of the present disclosure are described herein with reference to flow diagrams and block diagrams of methods, apparatus (systems), and computer program products according to embodiments of the disclosure. It will be understood by those skilled in the art that each block of the flow diagrams and block diagrams, and combinations of blocks in the flow diagrams and block diagrams, can be implemented by computer readable program instructions.

The computer readable program instructions that may implement the systems and methods described in this disclosure may be provided to one or more processors (and/or one or more cores within a processor) of a general purpose computer, special purpose computer, or other programmable apparatus to produce a machine, such that the instructions, which execute via the processor of the computer or other programmable apparatus, create a system for implementing the functions specified in the flow diagrams and block diagrams in the present disclosure. These computer readable program instructions may also be stored in a computer readable storage medium that can direct a computer, a programmable apparatus, and/or other devices to function in a particular manner, such that the computer readable storage medium having stored instructions is an article of manufacture including instructions which implement aspects of the functions specified in the flow diagrams and block diagrams in the present disclosure.

The computer readable program instructions may also be loaded onto a computer, other programmable apparatus, or other device to cause a series of operational steps to be performed on the computer, other programmable apparatus or other device to produce a computer implemented process, such that the instructions which execute on the computer, other programmable apparatus, or other device implement the functions specified in the flow diagrams and block diagrams in the present disclosure.

FIG. 9 is a functional block diagram illustrating a networked system 800 of one or more networked computers and servers that can implement the information processing unit 1. In an embodiment, the hardware and software environment illustrated in FIG. 9 may provide an exemplary platform for implementation of the software and/or methods according to the present disclosure.

Referring to FIG. 9, a networked system 800 may include, but is not limited to, computer 805, network 810, remote computer 815, web server 820, cloud storage server 825 and computer server 830. In some embodiments, multiple instances of one or more of the functional blocks illustrated in FIG. 9 may be employed.

Additional detail of computer 805 is shown in FIG. 9. The functional blocks illustrated within computer 805 are provided only to establish exemplary functionality and are not intended to be exhaustive. And while details are not provided for remote computer 815, web server 820, cloud storage server 825 and computer server 830, these other computers and devices may include similar functionality to that shown for computer 805.

Computer 805 may be a personal computer (PC), a desktop computer, laptop computer, tablet computer, netbook computer, a personal digital assistant (PDA), a smart phone, or any other programmable electronic device capable of communicating with other devices on network 810.

Computer 805 may include processor 835, bus 837, memory 840, non-volatile storage 845, network interface 850, peripheral interface 855 and display interface 865. Each of these functions may be implemented, in some embodiments, as individual electronic subsystems (integrated circuit chip or combination of chips and associated devices), or, in other embodiments, some combination of functions may be implemented on a single chip (sometimes called a system on chip or SoC).

Processor 835 may be one or more single or multi-chip microprocessors, such as those designed and/or manufactured by Intel Corporation, Advanced Micro Devices, Inc. (AMD), Arm Holdings (Arm), Apple Computer, etc. Examples of microprocessors include Celeron, Pentium, Core i3, Core i5 and Core i7 from Intel Corporation; Opteron, Phenom, Athlon, Turion and Ryzen from AMD; and Cortex-A, Cortex-R and Cortex-M from Arm.

Bus 837 may be a proprietary or industry standard high-speed parallel or serial peripheral interconnect bus, such as ISA, PCI, PCI Express (PCI-e), AGP, and the like.

Memory 840 and non-volatile storage 845 may be computer-readable storage media. Memory 840 may include any suitable volatile storage devices such as Dynamic Random Access Memory (DRAM) and Static Random Access Memory (SRAM). Non-volatile storage 845 may include one or more of the following: flexible disk, hard disk, solid-state drive (SSD), read-only memory (ROM), erasable programmable read-only memory (EPROM or Flash), compact disc (CD or CD-ROM), digital versatile disk (DVD) and memory card or stick.

Program 848 may be a collection of machine readable instructions and/or data that is stored in non-volatile storage 845 and is used to create, manage and control certain software functions that are discussed in detail elsewhere in the present disclosure and illustrated in the drawings. In some embodiments, memory 840 may be considerably faster than non-volatile storage 845. In such embodiments, program 848 may be transferred from non-volatile storage 845 to memory 840 prior to execution by processor 835.

Computer 805 may be capable of communicating and interacting with other computers via network 810 through network interface 850. Network 810 may be, for example, a local area network (LAN), a wide area network (WAN) such as the Internet, or a combination of the two, and may include wired, wireless, or fiber optic connections. In general, network 810 can be any combination of connections and protocols that support communications between two or more computers and related devices.

Peripheral interface 855 may allow for input and output of data with other devices that may be connected locally with computer 805. For example, peripheral interface 855 may provide a connection to external devices 860. External devices 860 may include devices such as a keyboard, a mouse, a keypad, a touch screen, and/or other suitable input devices. External devices 860 may also include portable computer-readable storage media such as, for example, thumb drives, portable optical or magnetic disks, and memory cards. Software and data used to practice embodiments of the present disclosure, for example, program 848, may be stored on such portable computer-readable storage media. In such embodiments, software may be loaded onto non-volatile storage 845 or, alternatively, directly into memory 840 via peripheral interface 855. Peripheral interface 855 may use an industry standard connection, such as RS-232 or Universal Serial Bus (USB), to connect with external devices 860.

Display interface 865 may connect computer 805 to display 870. Display 870 may be used, in some embodiments, to present a command line or graphical user interface to a user of computer 805. Display interface 865 may connect to display 870 using one or more proprietary or industry standard connections, such as VGA, DVI, DisplayPort and HDMI.

As described above, network interface 850, provides for communications with other computing and storage systems or devices external to computer 805. Software programs and data discussed herein may be downloaded from, for example, remote computer 815, web server 820, cloud storage server 825 and computer server 830 to non-volatile storage 845 through network interface 850 and network 810. Furthermore, the systems and methods described in this disclosure may be executed by one or more computers connected to computer 805 through network interface 850 and network 810. For example, in some embodiments the systems and methods described in this disclosure may be executed by remote computer 815, computer server 830, or a combination of the interconnected computers on network 810.

Data, datasets and/or databases employed in embodiments of the systems and methods described in this disclosure may be stored and or downloaded from remote computer 815, web server 820, cloud storage server 825 and computer server 830.

FIG. 10 is a diagram that shows the actuator control profile for a steering manufer and throttle control decided by the information processing unit 1 in the lane change example previously discussed. By applying a trained model for route selection in the scenario of FIG. 5, the information processing unit 1 determines that the vehicle should change to the left hand driving lane to avoid the forward vehicle 3. Once decided, the information processing unit 1 determines profiles of commands that it will dispatch to actuators, which in this case are the steering system and a throttle. Moreover, the information processing unit 1 in recognition that there may be some throttle lag provides a control signal to the throttle controller that increases throttle force between time t1 and t2, and then keeps the throttle steady from time t2 to t4. Once the speed has increased and the full engine tourque is realized, the command sent to the steering actuator causes the steering system to turn the vehicle toward the left lane from time t2 to t3, and then maintains the steering steady until turning back at time t5 so the vehicle will be traveling straight down the right lane. Just prior to causing the vehicle to turn back to the right at time t5, the information processing unit 1 controls the throttle force to drop from time t4 to t6, thus slowing the vehicle to a normal cruising speed.

By having the information processing unit 1 perform all of the analyses, model execution and command generation, it is possible for the information processing unit 1 to generation time-coordinated command profiles for different actuators. The present example is provided for throttle and steering, but here is merely illustrative of the commands and command profiles that the information processing unit 1 generates and dispatches for the other actuators discussed herein when executing other vehicle maneuvers. In addition to reducing processing load on the actuators, and increasing the coordination of vehicle actuators during vehicle movement control, the information processing unit 1 limits network congestion of the vehicle communication data bus and reduction of input/output processing drain on computer resources.

### Other Embodiments

In the embodiment described above, the information processing unit 1 configured as a single unit determines a target motion of the vehicle based on various signals and data related to the vehicle, and generates a control signal for each actuator 200 of the vehicle. However, for example, the information processing unit 1 may perform the processes up to the determination of the target motion, and the control signal for each actuator 200 of the vehicle may be generated by another information processing unit. In this case, the single information processing unit 1 does not include the energy management unit 50, and determines the target motion of the vehicle based on the various signals and data related to the vehicle and outputs data representing the target motion. Then, the other information processing unit receives the data output from the information processing unit 1 and generates a control signal for each actuator 200 of the vehicle.

### Description of Reference Characters

1 Information Processing Unit

2 Vehicle

10 Vehicle External Environment Estimation Unit

15 Vehicle External Environment Model

20 Driver State Estimation Unit

25 Human Model

30 Route Generation Unit

40 Target Motion Determination Unit

45 6DoF Model of Vehicle

50 Energy Management Unit

56 Vehicle Energy Model

1. A vehicle arithmetic system mounted in a vehicle and configured to calculate vehicle motion control parameters that dictate a motion of the vehicle and provide specific input to sub-component controllers to execute control of sub-components of the vehicle that individually effect a motion of the vehicle, the system comprising:
a single information processing circuitry configured to:
estimate a vehicle external environment including a road and an obstacle from outputs of sensors that obtain information of the vehicle external environment to obtain an estimated vehicle external environment,
generate a traveling route of the vehicle which avoids the obstacle in the estimated vehicle external environment to obtain a generated traveling route, and
determine, based on the generated traveling route, a target motion of the vehicle so that the vehicle travels along the generated traveling route; and
a sub-component controller that receives the specific input based on the target motion from the single information processing circuity and calculates and applies a control parameter based on the target motion to at least one of a steering control actuator, and a velocity control actuator that impart a change in vehicle movement in response to application of the control parameter to the one of the steering control actuator and the velocity control actuator.

2. The vehicle arithmetic system of claim 1, wherein
the single information processing circuitry is further configured to calculate a driving force, a braking force, and a steering angle to achieve the target motion.

3. The vehicle arithmetic system of claim 2, wherein
the single information processing circuitry is further configured to compare the driving force, the braking force, and the steering angle with a vehicle energy model, and generate control signals for actuators so as to achieve the driving force, the braking force, and the steering angle consistent with control conditions contained in the vehicle energy model.

4. The vehicle arithmetic system of claim 1, wherein
the single information processing circuitry is further configured to
receive an output from a sensor that measures a state of a driver and estimate the state of the driver including at least one of a physical behavior or a health condition to obtain an estimated driver state, and
to determine the generated traveling route based on the estimated driver state.

5. The vehicle arithmetic system of claim 4, wherein
the single information processing circuitry is configured to compare the output from the sensor that measures the state of the driver with a human model to obtain the estimated driver state.

6. The vehicle arithmetic system of claim 4, wherein
the single information processing circuitry is configured to determine the target motion of the vehicle, including a planar motion of the vehicle, changes in a vehicle posture in up/down directions, and the estimate of the state of the driver, so that the vehicle travels along the generated traveling route.

7. The vehicle arithmetic system of claim 1, wherein
the single information processing circuitry is configured to compare, with a vehicle external environment model, 3-dimensional information on surroundings of the vehicle, the 3-dimensional information being obtained from outputs of sensors that obtain information of the vehicle external environment so as to obtain the estimated vehicle external environment.

8. The vehicle arithmetic system of claim 1, wherein
the single information processing circuitry is configured to
estimate a planar motion of the vehicle and changes in a vehicle posture in up/down directions, in response to vehicle movement along the generated traveling route generated, by referring to a six degrees of freedom model of the vehicle, and
set the planar motion and the changes in the vehicle posture in the up/down directions estimated as the target motion of the vehicle,
the six degrees of freedom model of the vehicle includes modeled acceleration along three axes that include forward/backward, left/right, and up/down directions of the vehicle, and angular velocity along pitch, roll, and yaw.

9. The vehicle arithmetic system of claim 1, wherein:
the sub-component controller being powertrain electronic control circuitry.

10. The vehicle arithmetic system of claim 1, wherein:
the sub-component controller being a dynamic stability control microcomputer.

11. The vehicle arithmetic system of claim 1, wherein:
the sub-component controller being a brake microcomputer.

12. The vehicle arithmetic system of claim 1, wherein:
the sub-component controller being an electric power assist steering microcomputer.

13. The vehicle arithmetic system of claim 1, wherein:
the sub-component controller including at least one of an airbag controller, a driver assistance human machine interface controller.

14. The vehicle arithmetic system of claim 1, wherein:
the single information processing circuitry includes a non-transitory memory that includes a learned model stored therein, the single information processing circuitry is configured to receive signals from the sensors and execute arithmetic processing by application of a learned model to the received signals to determine the target motion of the vehicle.

15. The vehicle arithmetic system of claim 14, wherein:
the single information processing circuitry is configured to generate and apply control signals to the steering control actuator and the velocity control actuator based on the target motion.

16. The vehicle arithmetic system of claim 15, wherein:
the velocity control actuator being one of a brakes actuator and an acceleration actuator.

17. The vehicle arithmetic system of claim 14, wherein:
the learned model includes control logic that applies control parameters to further evolve the learned model to reflect driving characteristics exhibited by the vehicle when under driver control.

18. The vehicle arithmetic system of claim 14, wherein:
the learned model is a convolutional neural network.

19. A method for operating a vehicle arithmetic system mounted in a vehicle and configured to calculate vehicle motion control parameters that dictate a motion of the vehicle and provide specific input to sub-component controllers to execute control of sub-components of the vehicle that individually effect a motion of the vehicle, the method comprising:
controlling a single information processing circuitry to execute a learned model, the controlling including
receiving outputs from sensors that obtain information of a vehicle external environment,
estimating the vehicle external environment including a road and an obstacle to obtain an estimated vehicle external environment,
generating a traveling route of the vehicle which avoids the obstacle previously estimated to be present on the road based on the estimated vehicle external environment, and
determining, based on the traveling route, a target motion of the vehicle so that the vehicle travels along the traveling route; and
providing a sub-component controller with specific input based on the target motion from the single information processing circuity and calculating and applying a control parameter to one of a steering control actuator, and a velocity control actuator that imparts a change in vehicle movement in response to application of the control parameter to the one of the steering control actuator and the velocity control actuator.

20. The method of claim 19, wherein the learned model is a convolutional neural network.
